(19) United States
(12) Patent Application Publication
(10) Pub. No.: US 2012/0176123 A1
(43) Pub. Date: Jul. 12, 2012

(54) POSITION SENSOR

(75) Inventors: Yuichi MANABE, Inazawa-shi (JP); Tetsuji INOUE, Nagoya-shi (JP)

(73) Assignee: AISAN KOGYO KABUSHIKI KAISHA, OBU-SHI (JP)

(21) Appl. No.: 13/344,842

(22) Filed: Jan. 6, 2012

(30) Foreign Application Priority Data
Jan. 10, 2011 (JP) 2011-002601

(51) Int. Cl. G01B 7/14

(52) U.S. Cl. 324/207.17

(57) ABSTRACT

A position sensor is configured such that a rotor pattern formed on a rotor in a position facing a stator includes non-magnetic conductive parts cyclically formed, a stator coil includes an excitation coil and a detection coil, which are wound in the same direction, and the width of each coil is equal to one cycle of the rotor pattern.

### CROSS-REFERENCE TO RELATED APPLICATIONS

This application is based upon and claims the benefit of priority from the prior Japanese Patent Application No. 2011-002601 filed on Jan. 10, 2011, the entire contents of which are incorporated herein by reference

### TECHNICAL FIELD

The present invention relates to a position sensor to be used for detecting an operational position of a mover or rotor, the position sensor including a stator formed with a stator coil and the mover provided to be movable while facing the stator apart with a gap therefrom.

### BACKGROUND ART

As a conventional technique of the above type, for example, there is a rotation angle sensor which is widely used in various fields. In a vehicle engine, a crank angle sensor is adopted, which is one example of the rotation angle sensor, to detect rotation speed and rotation phase.

One example of this type of technique, there is known a rotary scale disclosed in Patent Document 1 listed below. This scale is provided with a rotor and a stator arranged to face each other. The rotor is provided with rotor-side coil patterns (search coil) and the stator is provided with stator-side coil patterns (excitation coil) placed to face the search coil. Further, the rotor includes a rotor-side rotary transformer, and the stator includes a stator-side rotary transformer facing the rotor-side rotary transformer. The rotor is attached on a rotary shaft of a motor or the like so that the rotor is integrally rotatable with the shaft. The stator is fixed to a housing of the motor or the like.

Herein, the excitation coil and the search coil are each formed in a zig-zag bent and entirely annular shape. In this rotary scale, when alternating current is supplied to the excitation coil, an excitation signal is generated, thus generating induced voltage cyclically (a cycle=a pattern pitch of the search coil) changeable with respect to a rotation angle of the rotor (search coil) (i.e., according to changes of electromagnetic coupling degree corresponding to changes in relatively positional relationship between the excitation coil and the search coil) in the search coil.

This induced voltage is transmitted from the rotor-side rotary transformer to the stator-side rotary transformer. From an amount of change in this induced voltage, a rotation angle of the rotor (i.e., a rotation shaft of a motor or the like to which the rotor is attached) is detected.

A conventional crank angle sensor is required only to give a resolution of about 10 degrees. However, because of recent emission control related to environmental issues, more accurate control of an engine is demanded. Accordingly, the resolution of the crank angle sensor has to be about 1 degree. For instance, when a pulse is to be output at every 1 degree while the engine is driven at 6000 rpm in rotation number, a signal of 36 kHz is required.

As one example of an accurate position sensor, Patent Document 2 discloses a position sensor configured such that a rotor pattern including protrusions and depressions arranged cyclically is formed on a surface of a rotor so that a pair of an excitation coil and a detection coil are arranged in parallel with no gap therebetween, each coil having an almost closed spiral outline. Herein, the width of each of the excitation coil and the detection coil is equal to the width of each protrusion of the rotor patterns. That is, each coil is formed with a width corresponding to a half cycle of the rotor pattern.

### RELATED ART DOCUMENTS

### Patent Documents

Patent Document 1: JP 2008-216154A
Patent Document 2: JP 2002-39793A

### DISCLOSURE OF THE INVENTION

### Problems to be Solved by the Invention

In the technique of Patent Document 2, however, a detection signal is weak and thus the position sensor has to be designed to have a larger entire size in order to generate a sufficient detection signal. This runs counter to the demand for size reduction.

The reason why the detection signal is weak was analyzed as below by the present applicant.

FIG. 10 is a schematic view of the technique of Patent Document 2. For instance, a protrusion 101 and a recess 102 both constituting a rotor pattern 103 have the same width, which is 4 degrees in terms of angle. Thus, one cycle of the rotor pattern 103 is 8 degrees. A pair of search coils 104 and 105 are placed in an inner circumference of an excitation coil 107 formed on a stator. The width of each search coil 104 and 105 corresponds to a half cycle (4 degrees) of the rotor pattern 103.

In a state shown in FIG. 10, the protrusion 101 faces the search coil 105 and the recess 102 faces the search coil 104. Electromotive force (Detected voltage) generated in the search coil 105 is therefore maximum while electromotive force generated in the search coil 104 is minimum. A search coil 106 is the total of the search coils 104 and 105.

FIG. 11 shows a state where the rotor pattern 103 is moved leftward in the figure by a half cycle from the position shown in FIG. 10. The protrusion 101 is located in a position corresponding to a midpoint between the search coils 104 and 105. Magnetic flux to be generated by the excitation coil 107 will be generated around coil wires. The magnetic flux provides a high magnetic flux density near the coil wires but a lower magnetic flux as it is far from the coil wires. In the state shown in FIG. 11, it is conceivable that the protrusion 101 for allowing a high magnetic flux density to pass therethrough is far from the coil wire portions of the excitation coil 107 located on either side and thus a magnetic flux generated is small and only a little electromotive force is generated in the detection coil.

In the state shown in FIG. 10, the coil wire portions of the excitation coil 107 located on either side are near the protrusion 101, so that a certain level of electromotive force (detected voltage) can be obtained. In the state shown in FIG. 11, on the other hand, the wire portions of the excitation coil 107 positioned on both sides are far from the protrusion, so that only a little electromotive force (detected voltage) can be obtained. Consequently, as a whole, a detected voltage value of a signal is low, resulting in a decreased in S/N ratio.

The present invention has been made in view of the circumstances and has a purpose to provide a position sensor with high S/N ratio.

### Means of Solving the Problems

(1) To achieve the above purpose, one aspect of the invention provides a position sensor including: a stator formed with a stator coil; and a mover movably provided while facing the stator with a gap therefrom, wherein a mover pattern formed on the mover in a position facing the stator includes non-magnetic conductive parts cyclically formed, the stator coil includes an excitation coil and a detection coil, and the excitation coil and the detection coil are wound in the same direction, and the excitation coil and the detection coil each have a width corresponding to one cycle of the mover pattern.

With the above configuration (1), the excitation coil and the detection coil have the same width which corresponds to one cycle of the mover pattern. Accordingly, when the coil wire of the excitation coil faces positions excepting the non-magnetic conductive parts (i.e., positions of the magnetic parts), a magnetic flux with high magnetic flux density generated around the coil wire of the excitation coil can produce large electromotive force (detected voltage) and a high S/N ratio.

(2) In the position sensor described in (1), preferably, the excitation coil includes a first excitation coil and a second excitation coil, and a pitch of the first excitation coil and a pitch of the second excitation coil are displaced from each other by a half cycle of the mover pattern, and the detection coil includes a first detection coil and a second detection coil, and a pitch of the first detection coil and a pitch of the second detection coil are displaced from each other by a half cycle of the mover pattern.

With the above configuration (2), the pair of coil wire portions of the first detection coil located on either side faces the magnetic parts, while the pair of coil wire portions of the second detection coil located on either side faces the non-magnetic conductive parts. Thus, a difference in generated electromotive force between the first detection coil and the second detection coil largely changes. When a signal value is obtained by differential amplification between the first detection coil and the second detection coil, a large signal value (S) can be obtained. The S/N ratio can be further increased.

(3) In the position sensor described in (1), preferably, the mover pattern is formed of a magnetic material applied and dried on a surface of the mover made of a non-magnetic conductive material.

With the above configuration (3), it is unnecessary to subject an outer peripheral surface of the mover to mechanical processing such as cutting as disclosed in Patent Document 2 to alternately form the non-magnetic conductive parts and the magnetic parts. Thus, cost reduction can be achieved.

(4) In the position sensor described in (1), preferably, the excitation coil and the detection coil are arranged in the same layer.

Specifically, in the coil structure having a multilayer configuration, the coils are arranged in the same layer.

With the above configuration (4), the excitation coil and the detection coil are wound doubly in the same layer. Thus, a fine coil wiring pattern can be formed by applying and drying a coil by an ink jet printer. The detection accuracy of the position sensor can be enhanced accordingly.

(5) In the position sensor described in (1), preferably, the excitation coil and the detection coil are arranged in overlapping relation.

Specifically, in the coil structure having a multi-layer configuration, the coils are formed in the different layers while interposing an insulation layer therebetween, and the excitation coil and the detection coil are placed in completely overlapping relation.

With the above configuration (5), the positions of the excitation coil and the detection coil in different layers can be made completely coincident with each other in the radial direction. Accordingly, the position sensor can provide high detection accuracy.

(6) In the position sensor described in (1), preferably, the excitation coil is to be given an excitation signal which is a high frequency wave of 1 MHz or more, a high-frequency detection signal passing through the detection coil is subjected to signal processing using an envelop detector.

It is conventionally known the use of high frequency waves can reduce the number of wiring patterns of the detection coil. With the above configuration (6), using the high frequency wave of 1 MHz or more, the detection coil can have the reduced number of wiring patterns. When a high frequency excitation signal is used, a detection signal is also output at high frequency. In the invention, the output high frequency signal is subjected to the signal processing using the envelop detector to produce a signal. Therefore, an accurate signal can be obtained by such a simple method.

(7) In the position sensor described in (1), preferably, the mover is a rotor movable plate which is rotated, and the excitation coil and the detection coil are formed on a flexible printed board, and the flexible printed board is integrally molded with resin on the stator.

With the above configuration (7), the stator facing a part of the rotor movable plate which is the rotatable body can be reduced in size. Accordingly, the position sensor can be provided in entirely compact size.

(8) In the position sensor described in (3), preferably, the mover pattern includes a part made of the magnetic material with a different thickness from the thickness of other parts to output a Z signal serving as a reference position signal.

With the above configuration (8), the magnetic material of a part of the mover pattern has only to be formed, for instance, to be thick for to generate the Z signal. Any additional device is not required. The Z signal can therefore be produced at low cost.

### BRIEF DESCRIPTION OF THE DRAWINGS

FIG. 1 is a diagram showing a first positional relationship between a first detection coil, a second detection coil, an excitation coil, and a rotor pattern in Example 1 of the invention;

FIG. 2 is a diagram showing configurations of the first detection coil, the second detection coil, and the excitation coil in Example 1;

FIG. 3 is a schematic view showing a whole structure of a rotary encoder;

FIG. 4 is a perspective view of a stator;

FIG. 5 is a diagram showing a second positional relationship between the first detection coil, the second detection coil, the excitation coil, and the rotor pattern;

FIG. 6 is a first operational explanation diagram of the first detection coil (the second detection coil, the excitation coil) and the rotor pattern;

FIG. 7 is a second operational explanation diagram of the first detection coil (the second detection coil, the excitation coil) and the rotor pattern;

FIG. 8 is a diagram showing configurations of a first detection coil, a second detection coil, a first excitation coil, and a second excitation coil in Example 2;

FIG. 9 is a block diagram of detection of a rotary encoder;

FIG. 10 is a schematic diagram showing a configuration of a conventional position sensor; and

FIG. 11 is a diagram showing a state where the rotor pattern is moved leftward in the figure by a half cycle from a state shown in FIG. 10.

### MODE FOR CARRYING OUT THE INVENTION

A detailed description of Example 1 embodying a position sensor of the present invention as a “rotary encoder which is a rotation angle sensor for a crank shaft” will now be given referring to the accompanying drawings.

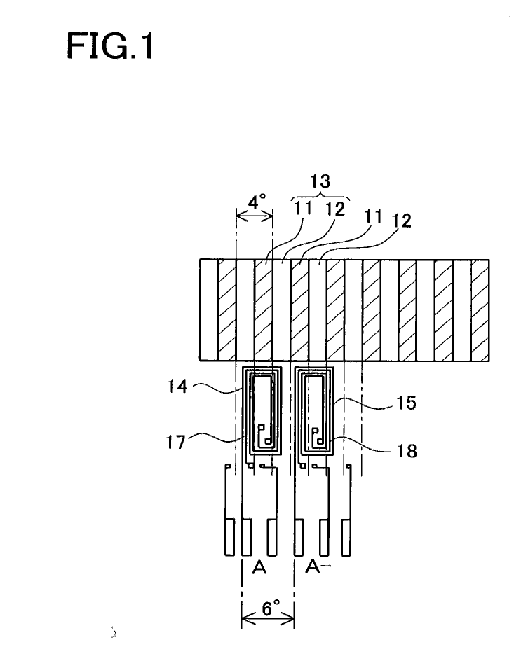

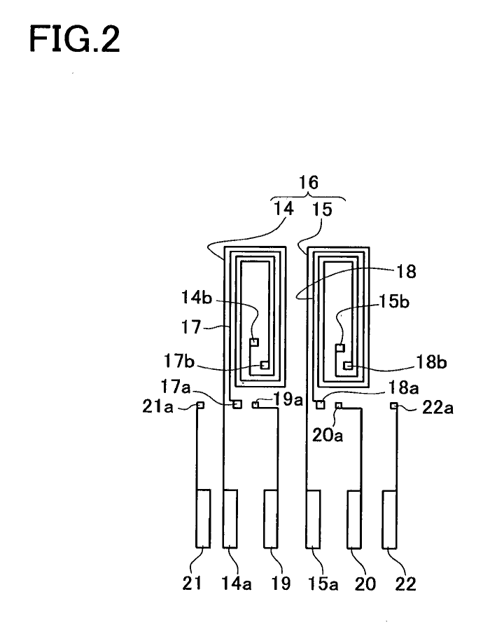

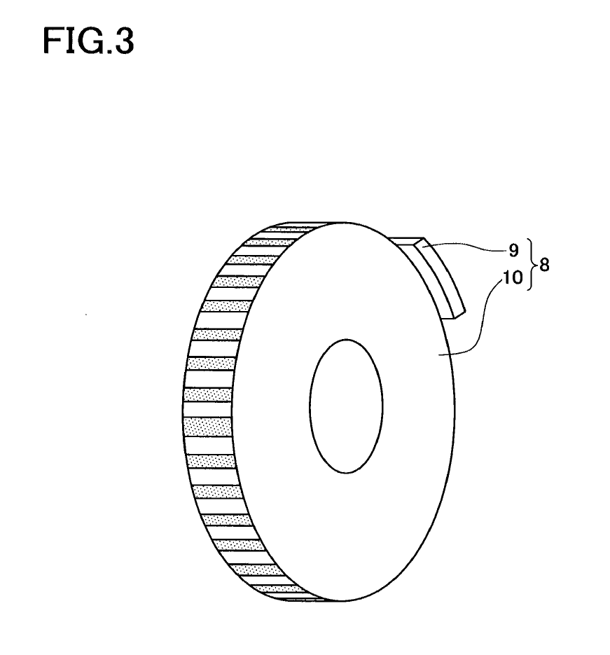

FIG. 3 is a schematic view showing a whole structure of a rotary encoder 8. The rotary encoder 8 includes a rotor (mover) 10 attached to a rotary shaft and a stator 9 fixedly provided to face a part of an outer periphery of the rotor 10. FIGS. 1 and 2 show a rotor pattern 13 formed on the outer periphery of the rotor 10, a detection coil 16 and excitation coils 17 and 18 constituting the stator 9. The rotor pattern 13 formed on the outer periphery is actually arranged along a circumference but illustrated in planar view for facilitating viewing.

The rotor 10 of this example is made of non-magnetic conductive metal and formed in a cylindrical shape having an outer diameter of 80 mm and a width of 10 mm (the thickness in a vertical direction in FIG. 1). The rotor pattern 13 is formed all over the outer periphery. The rotor 10 in this example is made of SUS (stainless steel) which is the non-magnetic metal but may be made of aluminum or others.

As shown in FIG. 1, the rotor pattern 13 is formed on the outer peripheral surface of the stainless-steel rotor 10 so that magnetic parts 11 are formed in a cycle. The angle (width) of each magnetic part 11 (in a lateral direction in FIG. 1) is set to 4 degrees. The magnetic parts 11 are formed by screen printing in which magnetic powder (magnetic material) mixed with a resin binder is applied in strip shape and then dried. The magnetic powder used in this example is ferrite but not limited thereto.

Portions not formed with the magnetic parts 11 provide non-magnetic conductive parts 12. The angle (width) of each non-magnetic conductive part 12 is set to 2 degrees equal to each magnetic part 11. The magnetic parts 11 and the non-magnetic conductive parts 12 constitute the rotor pattern 13. The angle (width) of the rotor pattern 13 is 4 degrees. The rotor pattern 13 is formed with 90 cycles on an entire circumference.

Herein, only continuous two of the magnetic parts 11 at 90 places in the rotor pattern 13 have the thickness double the thickness of other magnetic parts so that those two magnetic parts are used as a reference position of the rotor 10.

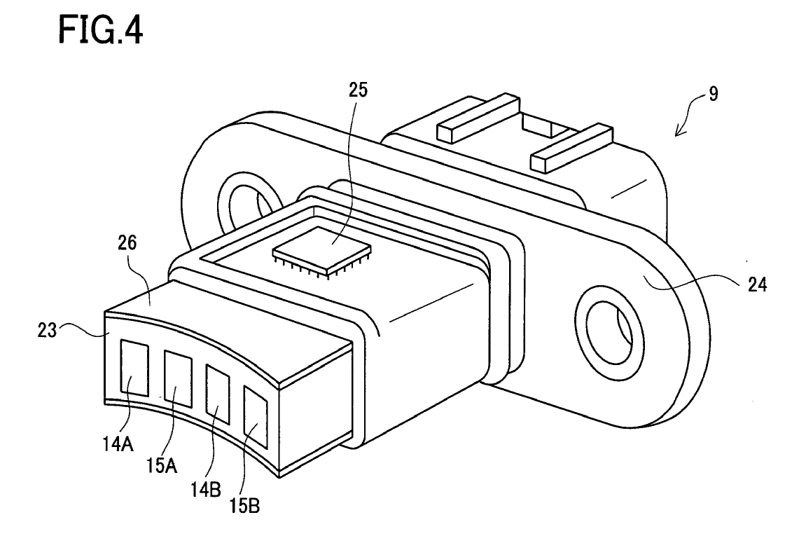

FIG. 4 shows a configuration of the stator 9. An attachment plate 24 is fixedly provided to a stator body 26. A circuit part 25 is provided on an upper surface of the stator body 26. In a final product, the circuit part 25 is covered by molding resin and hence externally invisible. In FIG. 4, however, a part of the resin is omitted to show the circuit part 25. A front end face of the stator body 26 is formed in an arc shape of a curvature complying with the curvature of the rotor 10. The front end face of the stator body 26 is provided with a flexible printed board 23 integrally molded.

The surface of the flexible printed board 23 is formed with two sets of detection coils 16 (14A, 15A; 14B, 15B) and two sets of excitation coils 17 and 18. The detection coils 16 and the excitation coils 17 and 18 are provided on the flexible printed board 23.

The detection coils 16 and the excitation coils 17 and 18 in Example 1 are shown in detail in FIG. 2. Each detection coil 16 includes a pair of a first detection coil 14 and a second detection coil 15. The first detection coil 14 is wound doubly together with the first excitation coil 17. Specifically, the first excitation coil 17 is located between portions of the first detection coil 14. Similarly, the second detection coil 15 is wound doubly together with the second excitation coil 18. Specifically, the second excitation coil 18 is located between portions of the second detection coil 15. The first detection coil 14 and the second detection coil 15 are wound respectively by about two turns. The first excitation coil 17 and the second excitation coil 18 are also wound respectively by about two turns.

The angle (width) of each of the first detection coil 14 and the first excitation coil 17 is set to 4 degrees corresponding to one cycle of the rotor pattern. Similarly, the angle (width) of each of the second d 15 and the second excitation coil 18 are set to 4 degrees which is one cycle of the rotor pattern.

The first detection coil 14 and the first excitation coil 17 are displaced by 2 degrees in phase (a half cycle of the rotor pattern 13) from the second detection coil 15 and the second excitation coil 18 as shown in FIG. 1. Specifically, if their cycles are synchronized, the first detection coil 14 and the first excitation coil 17 should be displaced by 4 degrees in angle from the second detection coil 15 and the second excitation coil 18. In this example, however, such a displacement is set to 6 degrees in angle, instead of 4 degrees, so that their phases are displaced from each other by 2 degrees.

An outer circumferential end of the first detection coil 14 forms a terminal 14a. An inner circumferential end 14b of the first detection coil 14 is connected to a connecting portion 19a of a terminal 19 in the other layer. An outer circumferential end 17a of the first excitation coil 17 is connected to a connecting portion 21a of a terminal 21 in the other layer.

An outer circumferential end of the second detection coil 15 forms a terminal 15a. An inner circumferential end 15b of the second detection coil 15 is connected to a connecting portion 20a of a terminal 20 in the other layer. An outer circumferential end 18a of the second excitation coil 18 is connected to an inner circumferential end 17b of the first excitation coil 17 in the other layer. An inner circumferential end 18b of the second excitation coil 18 is connected to a connecting portion 22a of a terminal 22 in the other layer.

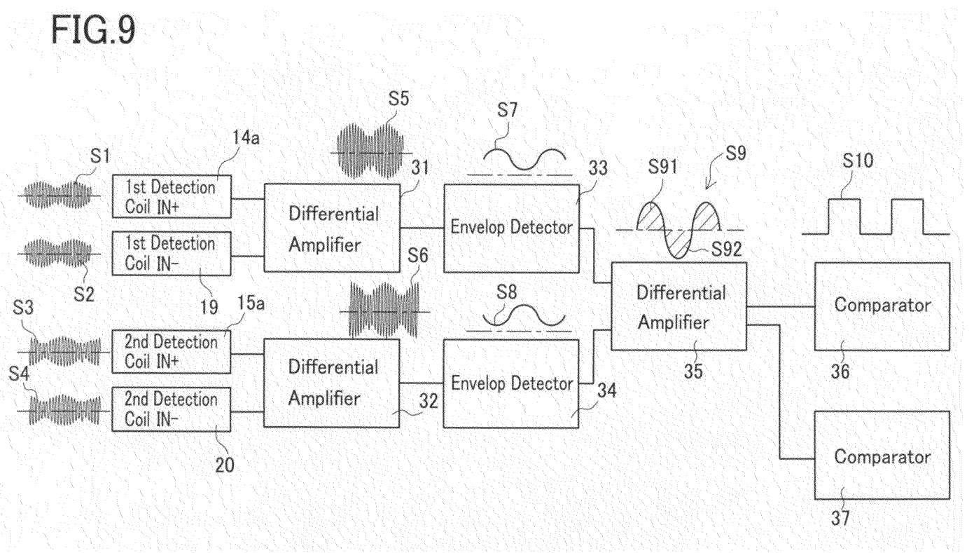

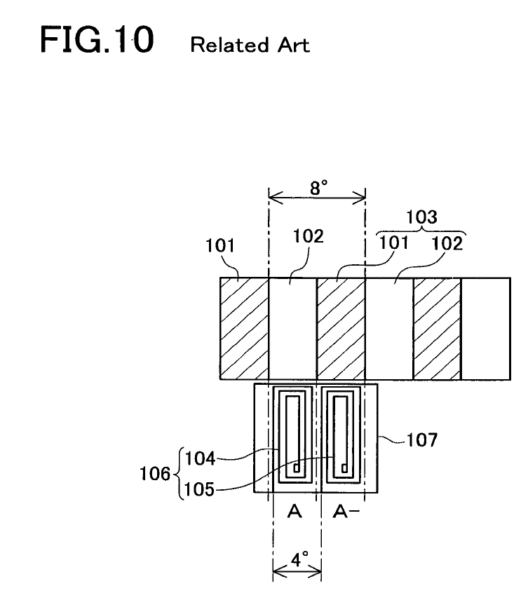

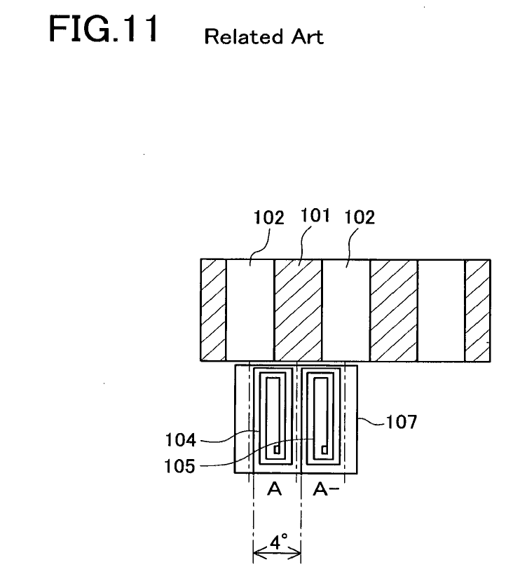

FIG. 9 is a block diagram of detection of the rotary encoder 8. In this example, high-frequency sine waves of 2 MHz are input into the excitation coils 17 and 18. By use of a high-frequency excitation signal, the number of turns of each detection coil 16 can be reduced. In this example, a high frequency of 2 MHz is used. When the number of turns of the detection coil 16 is set to a number corresponding to two cycles as in this example, a high frequency of 1 MHz may be used.

Output S1 of the terminal 14a of the first detection coil 14 and output S2 of the terminal 19 are input to a differential amplifier 31 and subjected therein to differential amplification, thus producing a signal S5. Simultaneously, output S3 of the terminal 15a of the second detection coil 15 and output S4 of the terminal 20 are input to a differential amplifier 32 and subjected therein to differential amplification, thus producing a signal S6.

Next, an outside envelop curve of the high frequency signal S5 obtained by the differential amplification in the differential amplifier 31 is envelope-detected by an envelop detector 33, thereby producing a signal S7. Further, an outside envelop curve of the high frequency signal S8 obtained by the differential amplification in the differential amplifier 32 is envelop-detected by an envelop detector 34, thereby producing a signal S8.

The output wave S7 of the envelop detector 33 and the output wave S8 of the envelop detector 34 are displaced from each other by half cycle in phase. This is because the first detection coil 14 and the second detection coil 15 are placed with a displacement of half cycle in phase from each other with respect to the rotor pattern 13.

The output wave S7 of the envelop detector 33 and the output wave S8 of the envelop detector 34 are input to a differential amplifier 35 so that both the waves are subjected to differential amplification, thereby producing a signal S9.

Successively, the output signal S9 of the differential amplifier 35 is input to a comparator 36 to obtain a pulse signal S10. By counting the pulse signal S10, a rotation angle of the rotor 10 with respect to the stator 9 can be calculated.

The output signal S9 of the differential amplifier 35 is also input to a comparator 37. A reference value of the comparator 37 is set to be larger than that of the comparator 36. Only an output signal larger than signals generated when the magnetic parts 11A thickly formed of a magnetic material come to the position of the detection coil 16 is selectively detected.

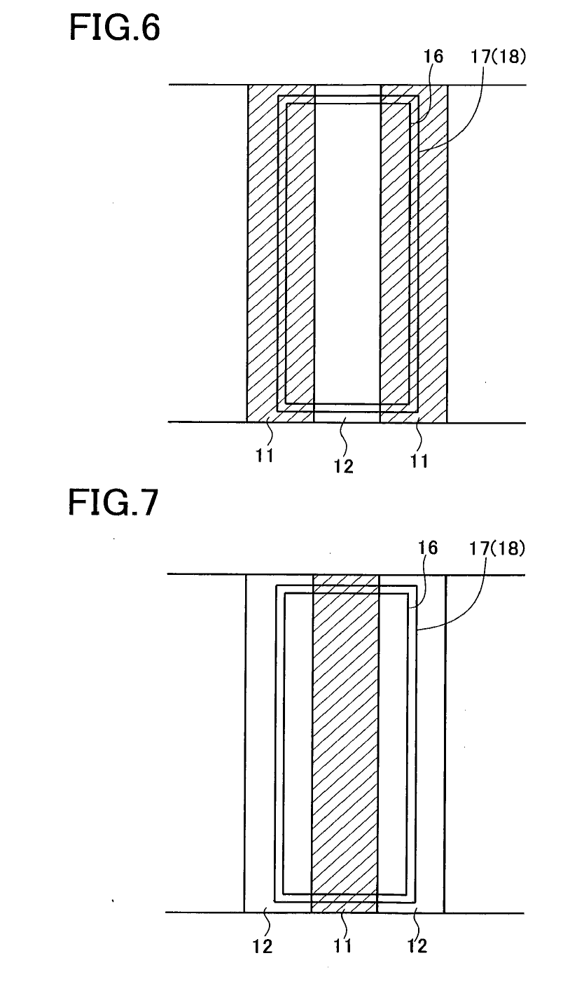

The operation of the rotary encoder 8 having the above configuration is explained below. FIG. 6 shows a state where the non-magnetic conductive part 12 is located inside the position of the detection coil 16 and the excitation coil 17 (18). FIG. 7 shows a state where the magnetic part 11 is located inside the position of the detection coil 16 and the excitation coil 17 (18).

In the state in FIG. 6, the magnetic flux generated near the coil wire portions of the excitation coil 17 (18) passes trough the inside of the magnetic part 11, thus generating a magnetic flux of high magnetic flux density. When the magnetic flux of high magnetic flux density is generated, a larger electromotive force is generated in the detection coil 16.

In the state in FIG. 7, on the other hand, the magnetic flux generated near the coil wire of the excitation coil 17 (18) passes through the non-magnetic conductive part 12. Since the non-magnetic conductive part 12 is made of non-magnetic conductive metal, eddy currents occur in the surface of the non-magnetic conductive part 12 and hence a magnetic flux is generated in an opposite direction to the magnetic flux generated in the excitation coil 17 (18) (a direction of canceling out a magnetic flux generated in the excitation coil 17 (18)). Therefore, the magnetic flux generated in the excitation coil 17 (18) is canceled out and made weaker, so that the electromotive force is little generated.

When the first detection coil 14 and the second detection coil 15 are positioned in a relationship with respect to the rotor pattern 13 as shown in FIG. 1, the first detection coil 14 is in the state shown in FIG. 7 and the second detection coil 15 is in the state shown in FIG. 6. Accordingly, a large electromotive force is generated in the second detection coil 15 but the electromotive force is hardly generated in the first detection coil 14.

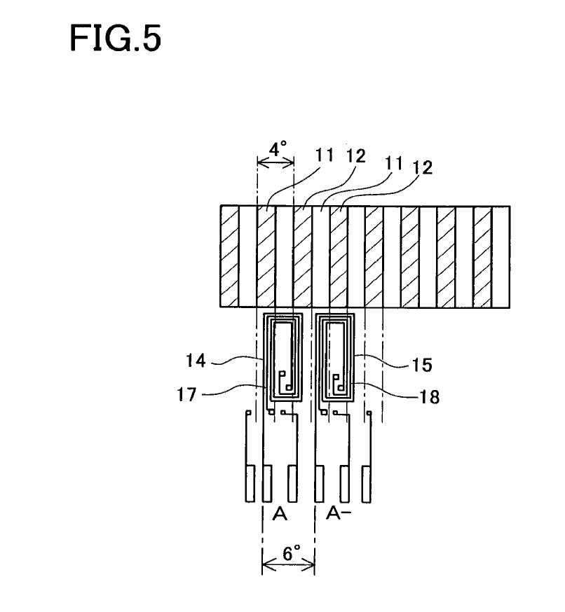

On the other hand, when the first detection coil 14 and the second detection coil 15 are in such a positional relationship with respect to the rotor pattern 13 as shown in FIG. 5, the first detection coil 14 is in the state shown in FIG. 6 and the second detection coil 15 is in the state shown in FIG. 7. Accordingly, a large electromotive force is generated in the first detection coil 14 but the electromotive force is hardly generated in the second detection coil 15.

A waveform of the first detection coil 14 is input to a positive input terminal of the differential amplifier 35 and a waveform of the second detection coil 15 is input to a negative input terminal of the differential amplifier 35. Thus, the output waveform S9 of the differential amplifier 35 becomes a waveform S91 on the positive side in the case of the positional relationship in FIG. 5 and a waveform S92 on the negative side in the case of the positional relationship in FIG. 1.

For instance, the width of each of the first detection coil 14 and the second detection coil 15 is equal to the width (angle) of one cycle of the rotor pattern 13. Accordingly, as shown in FIG. 1, the non-magnetic conductive part 12 fully comes to a position corresponding to the inside of the coil wire of the second detection coil 15 and the magnetic parts 11 are in the positions corresponding to the coil wire of the second detection coil 15. The second detection coil 15 can therefore produce a large electromotive force. Simultaneously, the magnetic part 11 fully comes to a position corresponding to the inside of the coil wire of the first detection coil 14 and the non-magnetic conductive parts 12 are in the positions corresponding to the coil wire of the first detection coil 14. The electromotive force is hardly generated in the first detection coil 14.

Please note that the coil width in this description represents an effective coil width, i.e., a value obtained by subtracting the width of the coil wire portions from a distance of an outermost circumference of a coil. This is different from the width of a space the coil occupies, such as the distance of the outermost circumference of a coil.

When the position of the magnetic part 11A comes to the position of the detection coil 16, amplitude of the output signal S9 of the differential amplifier 35 becomes larger. The comparator 37 selectively detects only such a large output signal and thus the reference position of the rotor 10 can be obtained as a Z signal based on an output signal of the comparator 37.

As explained above in detail, according to the rotary encoder 8 of Example 1 of the invention, the rotor pattern 13 formed in the position facing the stator 9 of the rotor 10 includes the non-magnetic conductive parts 12 formed in a cycle. The stator coil includes the excitation coils 17 and 18 and the detection coil 16 (14, 15). All the excitation coils 17 and 18 and the detection coil 16 are wound in the same direction. The widths of the excitation coils 17 and 18 and the detection coil 16 are equal to one cycle of the rotor pattern 13. The excitation coils 17 and 18 and the detection coil 16 have the same width corresponding to one cycle of the rotor pattern 13. Accordingly, when the coil wire of each excitation coil 17 and 18 faces the positions excepting the non-magnetic conductive parts 12 (the positions corresponding to the magnetic parts 11), a magnetic flux of a high magnetic flux density generated around the coil wires of the excitation coils 17 and 18 can provide a large electromotive force (detected voltage), thereby achieving a higher S/N ratio.

Furthermore, the excitation coil includes the first excitation coil 17 and the second excitation coil 18, and pitches of the first excitation coil 17 and the second excitation coil 18 are displaced by a half cycle of the rotor pattern 13. The detection coil 16 includes the first detection coil 14 and the second detection coil 15, and pitches of the first detection coil 14 and the second detection coil 15 are displaced by a half cycle of the rotor pattern 13. When a pair of coil wire portions of the first detection coil 14 faces the magnetic parts 11, a pair of coil wire portions of the first detection coil 15 face the non-magnetic conductive parts 12. Consequently, a difference in generated electromotive force between the first detection coil 14 and the second detection coil 15 largely varies. When a signal value is obtained by their differential amplification, producing a large signal value (S), the S/N ratio can be further increased.

The rotor pattern 13 is formed in such a manner that a magnetic material is applied to a surface of a non-magnetic conductive rotor and then dried. For alternately forming the non-magnetic conductive parts 12 and the magnetic parts 11, the rotor outer periphery does not need to be subjected to any mechanical processing such as cutting as disclosed in Patent Document 2. Therefore, cost reduction can be achieved.

Furthermore, the excitation coils 17 and 18 and the detection coil 16 are placed in the same layer. Since the excitation coils 17 and 18 and the detection coil 16 are wound doubly in the same layer, a fine coil wiring pattern can be formed by applying a coil by an ink jet printer and drying it. It is possible to enhance detection accuracy of the rotary encoder 8.

Furthermore, an excitation signal is a high frequency wave of 1 MHz or more. A high-frequency detection signal flowing through the detection coil 16 is subjected to signal processing using the envelop detector. Accordingly, the number of wiring patterns of the detection coil can be reduced. With use of the high-frequency excitation signal, a detection signal is also output at high frequency. In this example, the output high-frequency signal is subjected to the signal processing using the envelop detector to produce a signal. An accurate signal can be obtained by such a simple method.

The rotor 10 is a rotatable rotor. The excitation coils 17 and 18 and the detection coil 16 are formed on the flexible printed board 23. This board 23 is integrally molded with resin on the front end face of the stator body 26. Accordingly, the stator 9 facing a part of the rotor 10 can have a small size, so that an entirely compact position sensor is realized.

For outputting the Z signal which is the reference position signal, a part of the rotor pattern 13 is applied with a magnetic material with different thickness from the thickness of other parts. If only the magnetic material of a part of the rotor pattern 13 is formed, for example, to be thick, the Z signal can be obtained. Any additional device is not required. Thus, the Z signal can be produced at low cost.

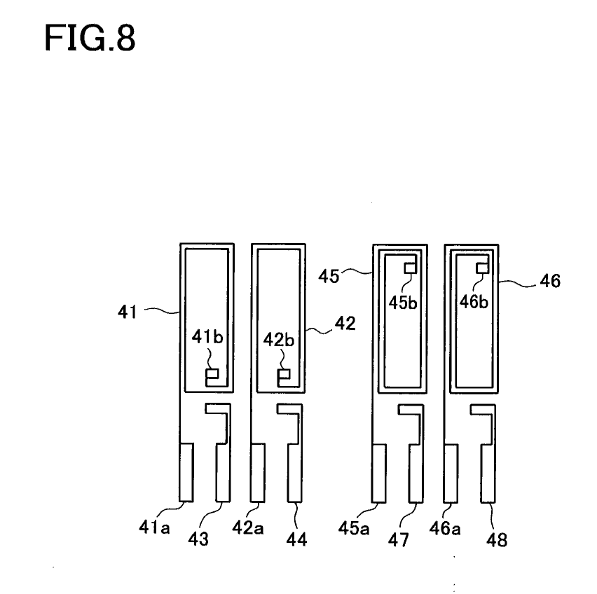

Example 2 of the invention will be explained below. Example 2 is substantially the same in configuration as Example 1 and hence only differences from Example 1 are described in detail. FIG. 8 shows a first detection coil 41, a second detection coil 42, a first excitation coil 45, and a second excitation coil 46 of Example 2.

The first detection coil 41 and the second detection coil 42 are formed in the same first layer. The first excitation coil 45 and the second excitation coil 46 are formed in a second layer placed on the first layer by interposing an insulation layer therebetween. In this example, the first detection coil 41 and the first excitation coil 45 are arranged in the different layers but in the fully overlapping positions. The second detection coil 42 and the second excitation coil 46 are arranged in the different layers but in the fully overlapping positions.

One end of the first detection coil 41 forms a terminal 41a and the other end 41b is connected to a terminal 43. One end of the second detection coil 42 forms a terminal 42a and the other end 42b is connected to a terminal 44.

One end of the first excitation coil 45 forms a terminal 45a, and the other end 45b is connected to a terminal 47. One end of the second excitation coil 46 forms a terminal 46a, and the other end 46b is connected to a terminal 48.

According to the rotary encoder 8 of Example 2, the first excitation coil 45 and the first detection coil 41 are placed in overlapping relation, and the second excitation coil 46 and the second detection coil 42 are placed in overlapping relation. Consequently, the positions of the excitation coil and the detection coil in the radial direction can be made completely coincident with each other in the different layers. Thus, the rotary encoder 8 can provide high detection accuracy.

The present invention is not limited to the above examples and may be embodied in other specific forms without departing from the essential characteristics thereof.

In the above examples, the rotary encoder 8 is designed for angle detection. As an alternative, a linear moving position sensor can be provided in which a wiring pattern of a detection coil and a rotor 10 are designed to be linear.

In the above examples, a mixture of magnetic powder and a resin binder is coated and dried to form the magnetic parts 11 of the rotor pattern 13. As an alternative, the rotor pattern 13 may be formed by sticking a magnetic sheet such as a sintered ferrite sheet.

In the above examples, a pattern is formed on the outer periphery of the rotor 10 and the excitation coils and the detection coil are arranged on the radially outside facing to the pattern. It may be arranged such that a pattern is formed on a surface of the rotor 10 in a rotational axis direction and an excitation coil and a detection coil are placed in axial positions facing to the pattern.

### DESCRIPTION OF THE REFERENCE SIGNS

8 Rotary encoder
9 Stator
10 Rotor
11 Magnetic part
12 Non-magnetic conductive part
14, 41 First detection coil
15, 42 Second detection coil
16 Detection coil (First detection coil+Second detection coil)
17, 18, 45, 46 Excitation coil

1. A position sensor including:
a stator formed with a stator coil; and
a mover movably provided while facing the stator with a gap therefrom,
wherein a mover pattern formed on the mover in a position facing the stator includes non-magnetic conductive parts cyclically formed,
the stator coil includes an excitation coil and a detection coil, and
the excitation coil and the detection coil are wound in the same direction, and the excitation coil and the detection coil each have a width corresponding to one cycle of the mover pattern.

2. The position sensor according to claim 1, wherein
the excitation coil includes a first excitation coil and a second excitation coil, and a pitch of the first excitation coil and a pitch of the second excitation coil are displaced from each other by a half cycle of the mover pattern, and
the detection coil includes a first detection coil and a second detection coil, and a pitch of the first detection coil and a pitch of the second detection coil are displaced from each other by a half cycle of the mover pattern.

3. The position sensor according to claim 1, wherein the mover pattern is formed of a magnetic material applied and dried on a surface of the mover made of a non-magnetic conductive material.

4. The position sensor according to claim 1, wherein the excitation coil and the detection coil are arranged in the same layer.

5. The position sensor according to claim 1, wherein the excitation coil and the detection coil are arranged in overlapping relation.

6. The position sensor according to claim 1, wherein the excitation coil is to be given an excitation signal which is a high frequency wave of 1 MHz or more,
a high-frequency detection signal passing through the detection coil is subjected to signal processing using an envelop detector.

7. The position sensor according to claim 1, wherein
the mover is a rotor movable plate which is rotated, and
the excitation coil and the detection coil are formed on a flexible printed board, and the flexible printed board is integrally molded with resin on the stator.

8. The position sensor according to claim 3, wherein the mover pattern includes a part made of the magnetic material with a different thickness from the thickness of other parts to output a Z signal serving as a reference position signal.
